(19) United States
(12) Patent Application Publication
(10) Pub. No.: US 2008/0231139 A1
(43) Pub. Date: Sep. 25, 2008

(54) Method for Production of a Commutator, as Well as Commutator

(76) Inventor: Ludvik Kumar, Spodnja Idrija (SI)

Correspondence Address: KATTEN MUCHIN ROSENMAN LLP, 575 MADISON AVENUE, NEW YORK, NY, 10022-2585, US

(21) Appl. No.: 11/664,481

(22) PCT Filed: Oct. 20, 2005
(86) PCT No.: PCT/EP05/11308

§ 371 Date: Mar. 30, 2007

(30) Foreign Application Priority Data
Nov. 30, 2004 (DE) 10 2004 057 750.1

(51) Int. Cl. H01R 39/04

(52) U.S. Cl. 310/233; 29/597

(57) ABSTRACT

The invention relates to a commutator comprising a support body (1), a plurality of conductor segments (13) that are secured in said body and a compensation unit (18) comprising several compensation elements (17), which electrically interconnect the conductor segments in pairs or groups. According to the invention, the compensation elements (17) are configured by wire sections (19) that are embedded in the support body. To produce a commutator of this type, at least the ends of the wire sections (19) that form the compensation elements and that are bent accordingly are connected to the assigned conductor segments (13) of an annular structure prior to the injection moulding of the support body (1). The injection moulding die (2) has a plurality of basin-shaped supporting limbs (31), which are arranged concentrically around the axis (5) of one of the sections of the injection moulding and with which the wire sections engage (19).

The present invention relates to a method for production of a commutator comprising a one-piece support member made of insulating molding compound, a plurality of metal conductor segments disposed in evenly spaced manner around an axis, and an equalizing device provided with a plurality of equalizing elements, wherein the conductor segments are anchored in the support member and are connected to one another in pairs or groups via equalizing elements embedded in the support member. The present invention also relates to a commutator comprising a one-piece support member made of insulating molding compound, a plurality of metal conductor segments disposed in evenly spaced manner around an axis, and an equalizing device provided with a plurality of equalizing elements, wherein the conductor segments are anchored in the support member and are connected to one another in pairs or groups via equalizing elements embedded in the support member.

It is known that those conductor segments that are supposed to have the same potential in commutators can be connected to one another in electrically conductive manner via equalizing elements, the totality of the individual equalizing elements forming one equalizing device. An advantage of such commutators is that multi-pole motors can be operated with a reduced number of brushes, which is favorable in particular with regard to the overall size. Furthermore, the pole fluxes are made uniform by connecting conductor segments of the same potential, thus also making the corresponding motor run more smoothly and reducing the loads on the bearings caused by asymmetric forces.

In a first design of such commutators, the equalizing elements are formed by wire portions, which are connected to the conductor segments (for example, to the connecting hooks for the rotor winding) after production of the commutator, and are laid outside the commutator, especially in the region of the circumference or an end face of the commutator (for example, see U.S. Pat. No. 6,320,293 B1, U.S. Pat. No. 3,484,634A, EP 1073182 A2, DE 19950370 B4 and JP 2001103714 A). A disadvantage here is in particular the danger of damage to the insulation of the exposed wire portions during production of the commutator and/or during operation of the machine equipped therewith, leading in turn to a short circuit between conductor segments at different potentials. In order to prevent this, it has been proposed that the wire portions forming the equalizing elements be laid in the armature slots provided therefor before the armature winding is wound (for example, see DE 19917579 A1 and JP 2003169458 A). A disadvantage of such a production procedure, in which the equalizing device is prepared in conjunction with the production of the armature winding only after the commutator has been manufactured, is the extra utilization of the winding machines, with the consequence of correspondingly reduced manufacturing capacity.

The two disadvantages explained in the foregoing do not exist in commutators of the class in question in which the equalizing device is already integrated into the respective commutator during production thereof and is therefore protected and also independent of the production of the armature winding. Admittedly, as is evident in the prior art (for example, see U.S. Pat No. 6,057,626 A and DE 3901905 C1), it is typically necessary in this case to use special equalizing elements stamped out of flat material, to ensure that they have sufficient strength to prevent them from being destroyed during subsequent injection molding of the support member with plasticated molding compound. The production and stocking of such specific equalizing elements leads to relatively high manufacturing costs for commutators of the class in question. According to DE 10116182 A1, the equalizing elements embedded in the support member are configured as metal bridging conductors, which are soldered or welded to the inside of the conductor segments. To ensure that these bridging conductors do not become inadmissibly deformed during injection molding of the support member, thus possibly leading to a short circuit, they must be made with high stiffness, or in other words with a relatively large cross section. In addition, the bridging conductors must be maintained at a minimum spacing from one another and from the conductor segments, again to avoid the danger of a short circuit due to contact after deformation during injection molding of the support member. This makes the design known from DE 10116182 A1 unsuitable for compact commutators with small dimensions.

In the case of a commutator whose support member comprises a plurality of prefabricated parts joined together, wherein the equalizing elements are disposed in an annular cavity between the support member and the conductor segments (see JP 60162451 A), the production costs are so high that it is not competitive for widespread use.

In the light of the prior art explained in the foregoing, the object of the present invention is to demonstrate a possibility for the production, at relatively low costs, of a commutator that belongs to the class in question and that is not susceptible to malfunctions even with compact dimensions.

This object is achieved according to the invention by the fact that a method for production of a commutator comprising a one-piece support member made of insulating molding compound, a plurality of metal conductor segments disposed in evenly spaced manner around an axis, and an equalizing device provided with a plurality of equalizing elements, wherein the conductor segments are anchored in the support member and are connected to one another in pairs or groups via equalizing elements embedded in the support member, comprises the following steps:
preparation of an annular structure surrounding the conductor segments;
preparation of a number of wire portions corresponding to the number of necessary equalizing elements, which portions are provided with a conductor and an insulating jacket surrounding it, each insulating jacket being stripped at both ends;
bending the wire portions in a middle region such that they have the shape of a bow;
connecting the ends of the conductors of the wire portions in electrically conductive manner to the associated conductor segments at the terminal elements disposed on the conductor segments;
loading the annular structure equipped with the wire portions into a multi-part injection-molding die, in such a way that, when the die is closed, the wire portions engage in a plurality of trough-shaped bracing elements disposed concentrically around the axis on one of the parts of the injection-molding die;
filling the mold cavity with plasticated molding compound, thus embedding the equalizing elements;
allowing the molding compound to cure;
opening the injection-molding mold and removing the commutator blank;
finish machining of the commutator blank.

The inventive method for production of a commutator provided with an equalizing device embedded in the one-piece support member made of molding compound is therefore characterized by the fact, among others, that there is used for production of the equalizing device a plurality of wire portions, which respectively comprise a conductor stripped at its ends but otherwise (for connection of respectively two conductor segments in pairs) surrounded by an insulating jacket and, after they have been bent forward in a middle region to the shape of a bow, are connected at their ends to well defined terminal elements on respectively two conductor segments, preferably at the radial inside thereof. Destruction of the equalizing elements formed by the wire portions during injection molding of the support member—which completely surrounds the wire portions—of plasticated molding compound is therefore effectively prevented by the fact that the wire portions are braced and fixed by bracing elements during injection molding of the support member, which bracing elements are disposed on one of the die sections of the injection-molding die and configured in the form of troughs, in such a way that the wire portions engage in the trough-shaped bracing elements when the annular structure already equipped with the wire portions is loaded into the injection-molding die and the injection-molding die is subsequently closed. This bracing of the equalizing elements during injection molding of the support member of plasticated molding compound makes it possible to configure them as portions of an extremely inexpensive conventional wire, which does not even have to have particular stiffness. By virtue of the respective insulation surrounding the conductors, no harm is done if the wire portions touch one another. For practical purposes, this means that the equalizing elements can be produced inexpensively by cutting appropriate portions to length from a wire stock, thus leading to considerable cost savings compared with known commutators of the class in question. In this connection, it also proves favorable that the same starting material can be used in the form of a common standard wire for the production of equalizing devices of the most diverse commutators. For example, by application of the present invention using the same starting material, it is even possible in particular to produce commutators in which three or more conductor segments are connected to one another in electrically conductive manner in groups via one wire portion each. In this case the insulating jacket of the wire portions is additionally stripped at one or more locations between the end regions, depending on the number of conductor segments to be joined to one another, the conductor exposed at such a location being connected at corresponding terminal elements to one or more further conductor segments.

According to the foregoing description, therefore, even if the invention is explained hereinafter with reference to (only) commutators in which the conductor segments are connected to one another in electrically conductive manner in pairs via equalizing elements, this is in no case to be construed as any kind of restriction of the invention to commutators of such configuration.

According to a first preferred improvement of the invention, it is provided that the wire portions are mechanically clamped at their ends by the conductor segments. For this purpose, for example, the conductor segments can each be provided on their radial inside with two clamping tabs, which project radially inward and are bent toward one another in order to clamp those ends of the wire portion in question that have been laid between them. Such clamping tabs can in particular be part of armature parts, by means of which the conductor segments are anchored in the support member. Such mechanical clamping of the wire portions with the conductor segments can represent the sole connection, or alternatively can represent merely mechanical fixation before the wire portions are soldered or welded together with the conductor segments, in the latter case by laser or resistance welding, for example. Of course, such mechanical clamping is in no way absolutely necessary within the scope of the present invention; to the contrary, soldering, bonding, joining with electrically conductive cement or the like without prior mechanical clamping can also be considered for connecting the wire portions to the conductor segments.

According to another preferred improvement of the invention, the conductors of the wire portions are made of copper. Various options can then be considered for the configuration of the respective insulating jacket of the wire portions. For example, the insulating jacket of the wire portions can be made of lacquer, Teflon or silicone. In this case, the choice of suitable material is based on the viewpoints of the (mechanical and thermal) stress on the insulation during production of the commutator, although for the major part of the applications of the present invention it is adequate—and particularly inexpensive—to form the insulating jacket from lacquer. As regards preparation of the wire portions, especially stripping of the insulating jacket at both ends thereof, another preferred improvement of the present invention is characterized by the fact that the insulating jacket is stripped from regions of a stock of wire, especially by turning, before the wire portions are cut to length by severing the conductor exposed at predetermined locations. Since a plurality of wire portions can be prepared simultaneously in this way, thus obviating clamping of individual wire portions in order to strip the insulating jacket from the respective two ends, such an approach is extremely advantageous from the viewpoints of costs. It is also particularly advantageous in cases in which the insulating jacket adheres so well to the conductor that it cannot be pulled in the form of a tube from the conductor in order to expose the conductor at the ends of the wire portions. Nevertheless, if the insulating jacket can be easily pulled completely in the form of a tube from the conductor, because its adhesion thereto is relatively weak, the wire portions can also be cut to length from a stock of wire before the insulating jacket is stripped at the ends.

The present invention can be implemented in conjunction with the most diverse commutator designs and the most different methods for production of commutators. In particular, it is suitable not merely for drum commutators, in which the terminal elements for the equalizing elements are expediently disposed on the radial inside of the conductor segments; to the contrary, it can also be used advantageously for flat commutators. Otherwise, it is also immaterial in this case whether the respective annular structure in which the conductor segments are disposed in their substantially final configuration is formed by a conductor blank, in which the conductor segments are connected to one another via bridges that are produced in one piece therewith and are to be removed later, or by a cage with individual conductor segments housed inside it. This is important only for those manufacturing steps that will be performed during finish machining of the commutator blank but that are adequately known as such from the production of comparable commutators without equalizing device. It is also immaterial for implementation of the present invention whether the brush running surface is disposed directly on the conductor segments or on carbon segments that are connected to the conductor segments in electrically conductive manner.

If the present invention is employed for a drum commutator, the bow-shaped regions of the wire portions of the equalizing device are disposed particularly preferably in the region of that end face of the support member at which the terminal lugs of the conductor segments are also disposed. This is advantageous in particular because the bracing elements, which in this case brace the wire portions during injection molding of the support member, are disposed in a particularly thick-walled region of the support member of typical commutator designs, so that the impressions that the bracing elements leave in the support member do not lead to impairment of the mechanical characteristics of the commutator. In addition, the injection zone for the molding compound in the mold cavity of the injection-molding mold can be chosen so particularly favorably in this case that the wire portions are forced into the trough-shaped bracing elements by the plasticated molding compound being injected into the mold.

Notwithstanding the particularly favorable arrangement of the bow-shaped regions of the wire portions adjacent to the terminal lugs as described in the foregoing, it is particularly preferable to dispose the terminal points at which the wire portions are connected at their ends to the conductor segments at a distance from the terminal hooks of the conductor segments. This is favorable both in regard to the accessibility of the terminal points during production of the inventive commutator and also in regard to the smallest possible thermal stress of the connections of the wire portions to the conductor segments during welding of the rotor winding to the terminal lugs of the commutator. To this extent it is particularly advantageous for drum commutators configured according to the present invention if the wire portions are respectively provided outside the middle region bent in the shape of a bow with two outer regions extending substantially parallel to the axis of the commutator, in such a way that the outer regions bridge over the axial distance between the bow-shaped regions of the wire portions and the terminal points. If such axial offset between the regions of the wire portions bent in the shape of a bow and the terminal points of the equalizing elements on the conductor segments is nevertheless not provided, the bare ends of the conductors stripped of the insulating jacket are obviously disposed immediately adjacent to the middle regions of the wire portions bent in the shape of a bow.

The outer regions of the wire portions running parallel to the commutator axis as explained in the foregoing can have different lengths in the individual wire portions. This makes it possible to dispose the bow-shaped middle regions of the wire portions in axially staggered manner in planes offset relative to one another in axial direction, even if the terminal points for the wire portions are disposed in a common plane. In this way, the middle regions of the wire portions formed with bow-shaped curvature can all have the same radius of curvature and be substantially disposed on a common cylindrical surface. This is favorable with regard to the smallest possible imbalance of the commutator and therefore for its useful life.

From the aspect of minimal imbalance, it is also particularly advantageous if the wire portions with which two oppositely disposed conductor segments are respectively connected to one another in pairs are disposed in such distributed manner around the axis that the number of wire portions routed through under each of the conductor segments (without contacting them) is smaller than or equal to one quarter of the number of conductor segments. In this sense, the wire portions-are preferably disposed such that, for example, there are passed through, without contact, three or four wire portions under each of the conductor segments in a commutator with 16 conductor segments, four wire portions under each of the conductor segments in a commutator with 18 conductor segments, and four or five wire portions under each of the conductor segments in a commutator with 20 conductor segments.

The present invention will be explained in more detail hereinafter on the basis of a preferred practical example illustrated in the drawing, wherein

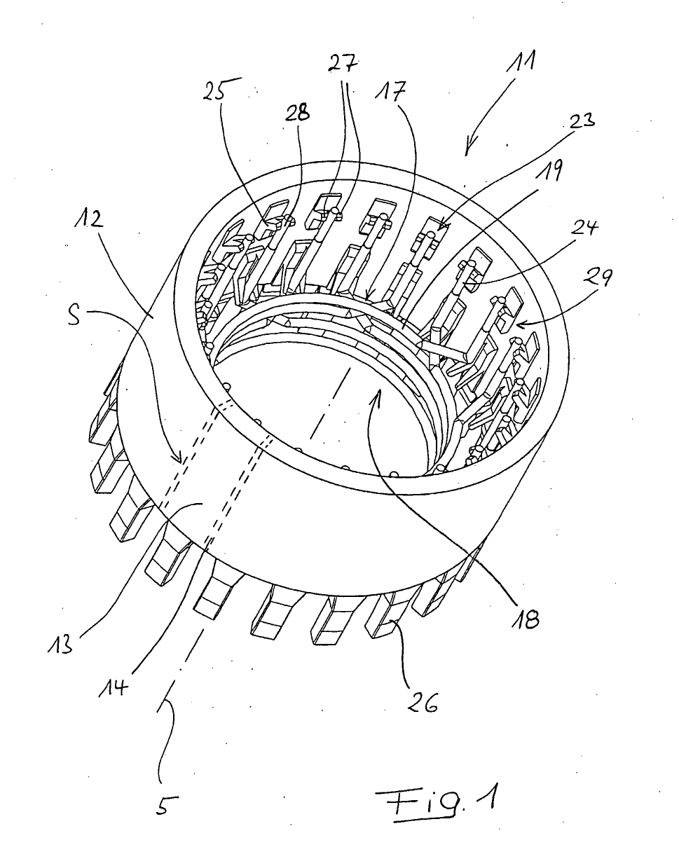

FIG. 1 shows a perspective view of a conductor blank with assembled equalizing elements, scheduled for further processing to a drum commutator according to the present invention,

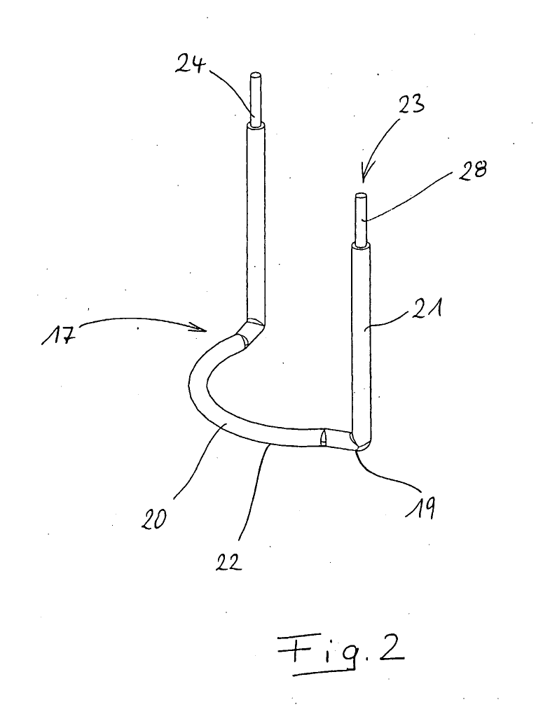

FIG. 2 shows a perspective view of a wire portion such as is used as one of the equalizing elements in the conductor blank according to FIG. 1,

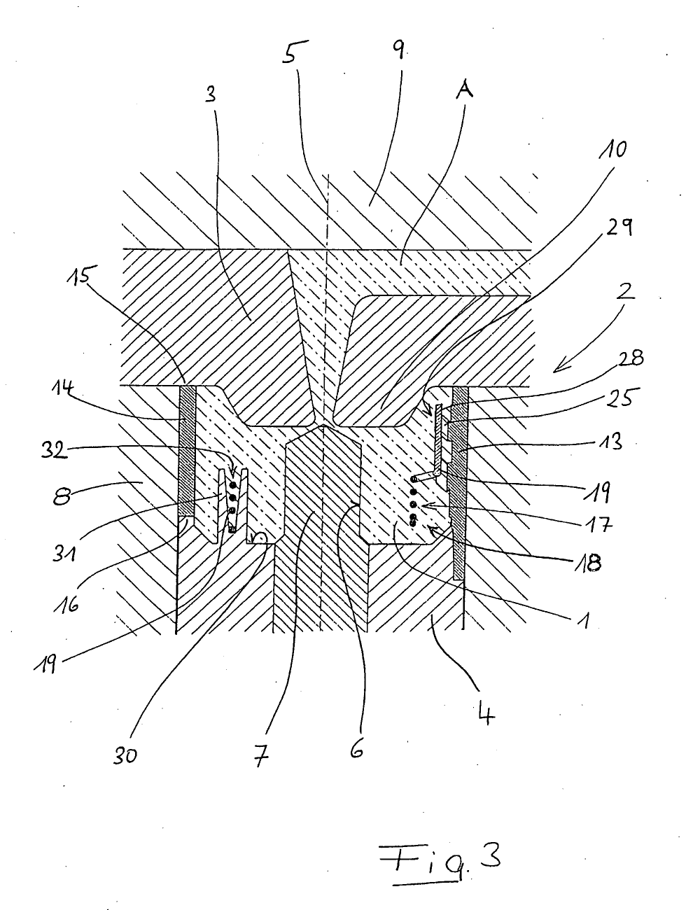

FIG. 3 shows an axial section through an injection-molding die during injection molding of a support member on the conductor blank according to FIG. 1, and

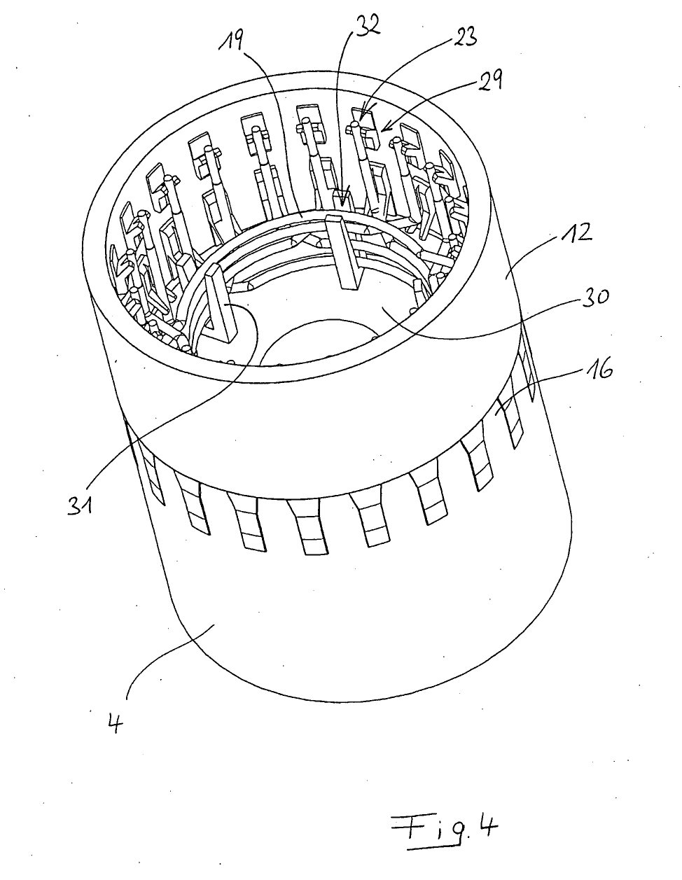

FIG. 4 shows the conductor blank according to FIG. 1, placed on the lower die of the injection-molding die according to FIG. 3.

Injection-molding die 2 used according to FIGS. 3 and 4 for injection-molding of support member 1 of the drum commutator comprises an upper die 3 and a lower die 4. To produce a bore 6 passing through support member 1 concentrically with axis 5 for the purpose of fixing the commutator on a rotor shaft, a cylindrical core 7 is housed in lower die 4. Lower die 4 is surrounded by a bracing shell 8; upper die 3 bears on a pressure plate 9, with which it jointly bounds sprue channel A. For production of a corresponding free space of support member 1 of the commutator, upper die 3 is provided with a conical projection 10.

An annular structure 11 in the form of a conductor blank 12 that is cylindrical for a predominant part of its length is loaded into the injection-molding die, which is illustrated in its closed position in the drawing. This blank comprises 20 conductor segments 13, wherein each two mutually adjacent conductor segments 13 are joined to one another via bridges 14, which are produced in one piece with the conductor segments and later, after the support member has cured and the commutator blank has been removed from the injection-molding die, are severed and removed, in order to separate conductor segments 13 from one another and to insulate them from one another. In the present practical example, bridges 14 have the same wall thickness as conductor segments 13, and so bridge 14 is represented by that material which is removed by means of saw cuts S during separation of conductor blank 12 into individual conductor segments 13. Via corresponding sealing zones 15 and 16, upper die 4 and lower die 5 close tightly against corresponding sealing faces of conductor blank 12.

To this extent the injection-molding die relies on the adequately known prior art, as is used in particular for the manufacture of common commutators without equalizing device, and so to this extent more detailed explanations are not needed.

Each two diametrically opposite conductor segments 13 are connected to one another in electrically conductive manner via one equalizing element 17 each. Accordingly, the corresponding drum commutator is provided with ten equalizing elements 17, which in combination form one equalizing device 18. Each of the ten equalizing elements is composed of a wire portion 19, which in turn is provided with a middle region 20 bent in the form of a semicircle and two outer regions 21, which extend parallel to axis 5 of the commutator. Wire portions 19 are composed of a copper conductor surrounded by an insulating jacket 22, the insulating jacket 22 being stripped in the region of the two ends 23, so that conductor 24 is exposed there.

For mechanical clamping of ends 23 of wire portions 19 with conductor segments 13, those of the respective two armature parts 25 that are mounted on the radial inside on conductor segments 13 and are disposed at a distance from terminal hooks 26—which are not yet bent in the conductor blank—are respectively provided with two clamping tabs 27, which receive and clamp between them the associated bare end 28 of conductor 24. To this extent corresponding armature parts 25 represent terminal elements 29, to which equalizing elements 17 are connected in electrically conductive manner to conductor segments 13. To improve the contacting, a soldered connection is additionally provided between bare end 28 of conductor 24 and armature parts 25. In view of the elongated form of terminal hooks 26 during production of support member 1, sealing zone 16 associated with lower die 4 is appropriately formed as a shoulder.

Lower die 4 of injection-molding die 2 is provided on its inner end face 30 with five bracing elements 31 disposed uniformly around axis 5 and projecting axially inward from each end face. They are substantially U-shaped, so that they have a trough 32 in which middle regions 20 of wire portions 19 bent in the form of semicircles engage when conductor blank 12 already equipped with equalizing elements 17 is loaded into lower die 4. During injection of the plasticated molding compound into closed injection-molding die 2 via sprue channel A opening into projection 10 of upper die 3, wire portions 19 are pressed firmly by the molding compound into bracing elements 31, so that they become securely fixed therein.

1. A method for production of a commutator comprising a one-piece support member (1) made of insulating molding compound, a plurality of metal conductor segments (13) disposed in evenly spaced manner around an axis (5), and an equalizing device (18) provided with a plurality of equalizing elements (17), wherein the conductor segments are anchored in the support member and are connected to one another in electrically conductive manner in pairs or groups via equalizing elements embedded in the support member, comprising the following steps:
preparation of an annular structure (11) surrounding the conductor segments (13);
preparation of a number of wire portions (19) corresponding to the number of necessary equalizing elements (17), which portions are provided with a conductor (24) and an insulating jacket (22) surrounding it, each insulating jacket being stripped at both ends;
bending the wire portions in a middle region (20) such that they have the shape of a bow;
connecting the ends (23) of the conductors (24) of the wire portions in electrically conductive manner to the conductor segments (13) at terminal points (29) disposed on the conductor segments;
loading the annular structure (11) equipped with the wire portions (19) into a multi-part injection-molding die (2), in such a way that, when the die is closed, the wire portions (19) engage in a plurality of trough-shaped bracing elements (31) disposed concentrically around the axis (5) on one of the parts of the injection-molding die;
filling the mold cavity with plasticated molding compound, thus embedding the wire portions (19);
allowing the molding compound to cure;
opening the injection-molding mold and removing the commutator blank;
finish machining of the commutator blank.

2. A method according to claim 1,
characterized in that
the wire portions (19) are mechanically clamped at their ends by the conductor segments (13).

3. A method according to claim 1,
characterized in that
the wire portions (19) are soldered or welded at their ends together with the conductor segments (13).

4. A method according to claim 1,
characterized in that
the wire portions (19) are formed into a configuration with a bow-shaped middle region (20) and two outer regions (21) extending substantially parallel to one another and protruding substantially at right angles out of the plane of the region curved in the shape of a bow, before the ends (23) of their conductors (24) are connected to the conductor segments.

5. A method according to claim 4,
characterized in that
the various wire portions (19) have outer portions (21) of different length.

6. A method according to claim 1,
characterized in that
the conductor segments (13) disposed opposite one another are connected to one another in pairs via the wire portions (19), the wire portions (19) being disposed in such distributed manner around the axis (5) that the number of wire portions routed through under each of the conductor segments (13) is smaller than or equal to one quarter of the number of conductor segments.

7. A method according to claim 1,
characterized in that
the insulating jacket (22) is stripped from regions of a stock of wire, and then the wire portions (19) are cut to length by severing the exposed conductor (24).

8. A method according to claim 1,
characterized in that
the wire portions (19) are cut to length from a stock of wire before the insulating jacket (22) is stripped at the ends of the wire portions that have been cut to length.

9. A method according to claim 1,
characterized in that
the annular structure (11) is formed by a conductor blank (12), in which the conductor segments (13) are connected to one another via bridges (14) that are produced in one piece therewith.

10. A method according to claim 1,
characterized in that
the annular structure (11) is formed by a cage with individual conductor segments (13) housed inside it.

11. A method according to claim 1,
characterized in that
the conductors (24) of the wire portions (19) are made of copper.

12. A method according to claim 1,
characterized in that
the insulating jacket (22) of the wire portions (19) is made of lacquer, Teflon or silicone.

13. A commutator comprising a one-piece support member (1) made of insulating molding compound, a plurality of metal conductor segments (13) disposed in evenly spaced manner around an axis (5), and an equalizing device (18) provided with a plurality of equalizing elements (17), wherein the conductor segments are anchored in the support member and are connected to one another in pairs or groups via equalizing elements embedded in the support member,
characterized in that
the equalizing elements (17) are formed by wire portions (19) that have a bowed middle portion (20) and are respectively provided with a conductor (24) and an insulating jacket (22) surrounding it, the insulating jacket being stripped at both ends and the bare ends (28) of each conductor being connected to two conductor segments (13) at terminal points (29) disposed on the radial inside thereof.

14. A commutator according to claim 13,
characterized in that
the wire portions (19) respectively have a middle region (20) curved in the shape of a bow and two outer regions (21) extending substantially parallel to the commutator axis (5).

15. A commutator according to claim 14,
characterized in that
the middle regions (20) of the individual wire portions (19) are disposed in different planes, and the outer regions (21) of the individual wire portions (19) have different lengths.

16. A commutator according to claim 13,
characterized in that
the conductor segments (13) disposed opposite one another are connected to one another in pairs via the wire portions (19), the wire portions (19) being disposed in such distributed manner around the axis (5) that the number of wire portions routed through under each of the conductor segments (13) is smaller than or equal to one quarter of the number of conductor segments.

17. A commutator according to claim 13,
characterized in that
it is configured as a drum commutator, the bow-shaped middle regions (21) of the wire portions (19) being disposed adjacent to that end face of the support member (1) on which the terminal lugs of the conductor segments (13) are disposed.

18. A commutator according to claim 17,
characterized in that
the terminal points for the wire portions (19) are disposed adjacent to the end face of the support member (1) opposite the terminal lugs.
